(19) United States
(12) Patent Application Publication
(10) Pub. No.: US 2012/0308155 A1
(43) Pub. Date: Dec. 6, 2012

(54) IMAGE PROCESSOR, DISPLAY DEVICE, AND IMAGE PROCESSING METHOD

(75) Inventors: Akiko Satoh, Osaka-shi (JP); Xiaomang Zhang, Osaka-shi (JP)

(73) Assignee: SHARP KABUSHIKI KAISHA, Osaka-shi, Osaka (JP)

(21) Appl. No.: 13/578,024

(22) PCT Filed: Feb. 9, 2011
(86) PCT No.: PCT/JP2011/053316

§ 371 Date: Aug. 9, 2012

Related U.S. Application Data
(60) Provisional application No. 61/303,500, filed on Feb. 11, 2010.

(51) Int. Cl. G06K 9/36; G06K 9/40

(52) U.S. Cl. 382/274

(57) ABSTRACT

An image processor (10) according to the present invention includes: a luminance segmentation section (12) arranged to segment an input image into a plurality of regions having different luminance levels from one another; a spatial frequency calculation section (14) arranged to calculate a spatial frequency of each of the plurality of regions; a contrast adjustment section (16) arranged to adjust a contrast of each of the plurality of regions based on the luminance level and the spatial frequency calculated by the spatial frequency calculation section (14); and a merging section (18) arranged to merge the plurality of regions, whose contrasts have been adjusted by the contrast adjustment section (16), into one image.

### TECHNICAL FIELD

The present invention relates to image processors. The present invention also relates to display devices and image processing methods.

### BACKGROUND ART

In recent years, it has been proposed to widen the dynamic range of display devices. Commonly-used conventional display devices are called “low dynamic range (LDR) displays”. In contrast, display devices having a wider dynamic range are called “high dynamic range (HDR) displays”. HDR displays can reproduce very low and high luminance levels which cannot be reproduced by LDR displays. Therefore, HDR displays can suitably display even images which have been subjected to a contrast enhancing processing.

Most of the image processing techniques in contrast manipulation are based on the assumption that the response of the human visual system (HVS) changes linearly with respect to the change in adaptation luminance (Weber's law). However, contrast sensitivity of the human visual system drastically decreases at low adaptation luminance levels.

FIG. 9 shows a contrast versus intensity (CVI) function for rods and cones in the human retina. In FIG. 9, the horizontal axis represents luminance [log₁₀ cd/m²] and the vertical axis shows a CVI function which can be derived by CVI=TVI(L)/L, where TVI(L) is a threshold versus intensity (TVI) function and L is the adaptation luminance level. The TVI function represents the minimum luminance difference that can be perceived by humans. As shown in FIG. 9, as the adaptation luminance decreases, contrast sensitivity of the human visual system also decreases, especially at low adaptation luminance levels.

Accordingly, when executing image processing, even if a constant physical contrast change is applied globally to the whole of an image, the change in “perceived contrast” (i.e., contrast as perceived by humans) will not be constant across all adaptation luminance levels. FIG. 10 shows an example of the relationship between luminance and perceived contrast. As shown in FIG. 10, especially at low luminance levels, perceived contrast change is not constant.

This problem is tolerable in LDR displays which cannot reproduce such low luminance levels, but is serious for HDR displays. Specifically, on HDR displays, any simple contrast rescaling may lead to a weakening of the perceived contrast in dark regions of an image.

In view of this, the present inventor, along with others, has proposed a contrast enhancement model which can be suitably used for HDR displays (see, Non-Patent Literature 1). This model is based on psychophysical experiments to measure contrast scaling with respect to different adaptation luminance levels on a HDR display which is displaying a natural landscape image. The contrast enhancement model can produce uniform changes in perceived contrast for different adaptation luminance levels.

### CITATION LIST

### Non-Patent Literature

Non-Patent Literature 1: Akiko Yoshida and three others, “Perception-based contrast enhancement model for complex images in high dynamic range”, Proceedings of Human Vision and Electronic Imaging XIII, IS&T/SPIE's 20th Annual Symposium Electronic Imaging, San Jose, Calif., USA, 2008

### SUMMARY OF INVENTION

### Technical Problem

However, the experiments were conducted only with respect to one landscape image. In addition, the contrast enhancement model completely ignores the characteristics of spatial frequency of an image. That is to say, the model is based on only one combination pattern of spatial frequency and adaptation luminance level. As a result, the contrast enhancement model disclosed in Non-Patent Literature 1 lacks generality in terms of its applicability.

The present invention has been made in view of the aforementioned problems, and an objective thereof is to provide an image processor and an image processing method which can achieve uniform changes in perceived contrast across arbitrary adaptation luminance levels including very low luminance levels that cannot be reproduced on LDR displays, arbitrary types of images, and arbitrary spatial frequencies.

### Solution to Problem

An image processor according to the present invention is an image processor including: a luminance segmentation section arranged to segment an input image into a plurality of regions having different luminance levels from one another; a spatial frequency calculation section arranged to calculate a spatial frequency of each of the plurality of regions; a contrast adjustment section arranged to adjust a contrast of each of the plurality of regions based on the luminance level and the spatial frequency calculated by the spatial frequency calculation section; and a merging section arranged to merge the plurality of regions, whose contrasts have been adjusted by the contrast adjustment section, into one image.

In a preferred embodiment, the merging section performs the merging after blurring contours of the plurality of regions.

In a preferred embodiment, the contrast adjustment section adjusts the contrasts of the respective regions to mutually different extents.

In a preferred embodiment, the image processor according to the present invention further includes a setting input section arranged to allow a user to designate an extent of adjustment by the contrast adjustment section.

A display device according to the present invention includes the image processor of the above construction and a display panel arranged to display the image outputted from the image processor.

In a preferred embodiment, the display device according to the present invention is capable of performing display with a luminance of less than 3 cd/m² and with a luminance of more than 400 cd/m².

In a preferred embodiment, the display panel includes a pair of substrates and a liquid crystal layer provided between the pair of substrates.

In a preferred embodiment, the display device according to the present invention further includes an illuminator arranged to emit light toward the display panel.

In a preferred embodiment, the illuminator has a plurality of light emitting regions and is capable of controlling a luminance of each of the plurality of light emitting regions.

In a preferred embodiment, the display device according to the present invention further includes an illumination sensor arranged to detect an ambient illumination level.

An image processing method according to the present invention is an image processing method including the steps of: segmenting an input image into a plurality of regions having different luminance levels from one another; calculating a spatial frequency of each of the plurality of regions; adjusting a contrast of each of the plurality of regions based on the luminance level and the calculated spatial frequency; and merging the plurality of regions, whose contrasts have been adjusted, into one image.

### Advantageous Effects of Invention

According to the present invention, there is provided an image processor and an image processing method which can achieve uniform changes in perceived contrast across arbitrary adaptation luminance levels including very low luminance levels that cannot be reproduced on LDR displays, arbitrary types of images, and arbitrary spatial frequencies.

### BRIEF DESCRIPTION OF DRAWINGS

FIG. 1 A block diagram schematically showing a display device 100 according to a preferred embodiment of the present invention.

FIG. 2 A block diagram schematically showing an image processor 10 included in the display device 100.

FIG. 3 A diagram showing an example of an input image.

FIGS. 4(a), (b) and (c) show three regions into which the input image shown in FIG. 3 is segmented.

FIGS. 5(a) and (b) show images having mutually different spatial frequencies.

FIG. 6 A block diagram schematically showing the display device 100 according to a preferred embodiment of the present invention.

FIG. 7 A diagram showing an example of a specific configuration for obtaining a high dynamic range.

FIG. 8 A block diagram schematically showing the display device 100 according to a preferred embodiment of the present invention.

FIG. 9 A graph showing a contrast versus intensity (CVI) function for rods and cones in the human retina.

FIG. 10 A graph showing an example of the relationship between luminance and perceived contrast.

### DESCRIPTION OF EMBODIMENTS

Hereinafter, a preferred embodiment of the present invention will be described with reference to the accompanying drawings. Note that the present invention is not to be limited to the following embodiment.

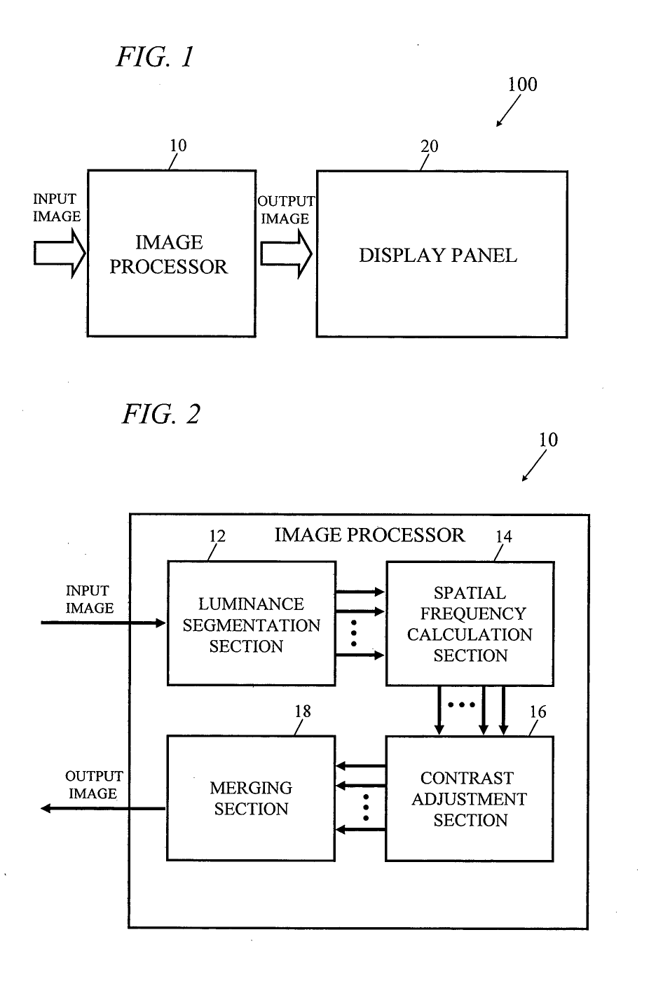

FIG. 1 is a block diagram schematically showing a display device 100 according to the present embodiment. As shown in FIG. 1, the display device 100 includes an image processor 10 and a display panel 20.

The display device 100 is a high dynamic range (HDR) display which has a wider dynamic range than those of low dynamic range (LDR) displays. As used herein, “LDR displays” are conventional display devices which cannot reproduce very low and very high luminance levels.

Typically, LDR displays are not capable of performing display with a luminance of less than 3 cd/m² or with a luminance of more than 400 cd/m². “HDR displays” are the opposite of LDR displays. Typically, HDR displays are capable of performing display even with a luminance of less than 3 cd/m² and with a luminance of more than 400 cd/m². A LDR image is of a traditional image format usually having 255 gray levels. On the other hand, a HDR image is one that covers a wider dynamic range, i.e., more gray levels. Accordingly, HDR images require a higher bit-depth such as 10 to 16 bits. Some practical examples of formats for HDR images are OpenEXR, RadianceHDR, Floating-point TIFF, etc.

The image processor 10 can execute image processing including contrast adjustment processing for input images. The display panel 20 displays images outputted from the image processor 10. The display panel 20 is a liquid crystal display (LCD) panel or an organic electro-luminescence display panel, for example.

Hereinafter, with reference to FIG. 2, the image processor 10 according to the present embodiment will be described in detail. FIG. 2 is a block diagram schematically showing the image processor 10. As shown in FIG. 2, the image processor 10 includes a luminance segmentation section 12, a spatial frequency calculation section 14, a contrast adjustment section 16 and a merging section 18.

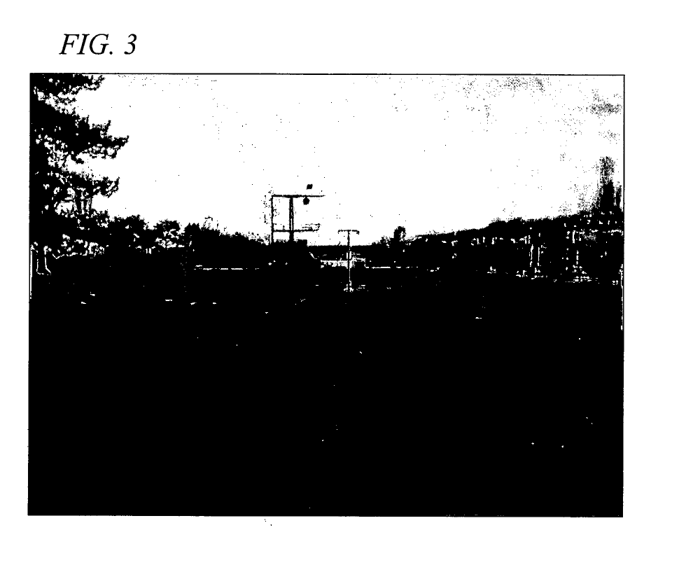

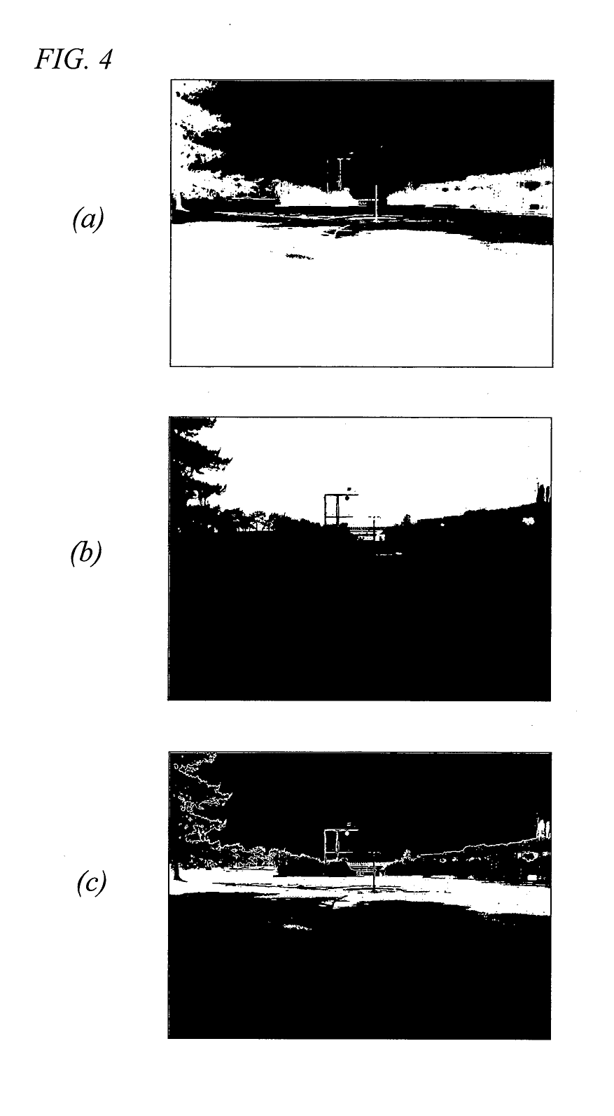

The luminance segmentation section 12 segments an input image into a plurality of regions having different luminance levels from one another. FIG. 3 shows an example of an input image. The input image shown in FIG. 3 is segmented by the luminance segmentation section 12 into three regions as shown in FIGS. 4(a), (b) and (c), for example. The region shown in FIG. 4(a) is a “dark region” which has low luminance levels. The region shown in FIG. 4(b) is a “bright region” which has high luminance levels. The region shown in FIG. 4(c) is a “medium region” which has medium luminance levels.

The segmentation by the luminance segmentation section 12 can be performed based on a luminance histogram of an input image, for example. Note that an input image does not need to be segmented into three regions, but may be segmented into two regions, or segmented into four or more regions.

The spatial frequency calculation section 14 calculates a spatial frequency of each of the plurality of regions. A “spatial frequency” is a characteristic of any structure that has periodicity across positions in space. Hereinafter, a spatial frequency of an image will be briefly explained with simple examples.

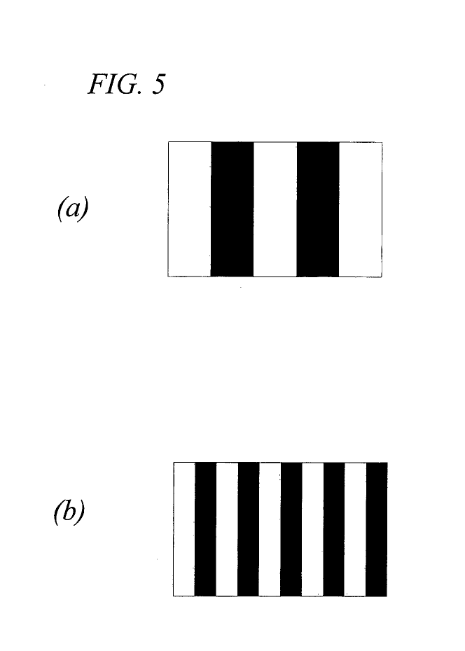

FIGS. 5(a) and (b) show images having mutually different spatial frequencies. In the image shown in FIG. 5(a), the luminance level changes every 10 pixels. On the other hand, in the image shown in FIG. 5(b), the luminance level changes every 5 pixels. A spatial frequency of an image is usually given in the unit of “cycles per degree (cpd)”. This means how many cycles of luminance changes occur in one visual angle. The visual angle (V) is defined as V=2·arc tan(S/2D), where S is the size [m] of an object of viewing (a display device) and D is a distance thereto [m].

A spatial frequency indicates how many cycles appear per unit visual degree. Once a visual degree is computed for a certain viewing distance and a certain display device, “pixels per degree” can also be derived. In the examples shown in FIGS. 5(a) and (b), if there are 10 pixels per unit visual degree, the spatial frequency of the example shown in FIG. 5(a) is 0.5 cpd, and that of the example shown in FIG. 5(b) is 1 cpd.

The calculation of a spatial frequency by the calculation section 14 may be performed with known techniques. Specifically, a spatial frequency of each of the regions may be calculated by the Fourier transform, for example. The general formula of the Fourier transform is as follows:

$$F ( k ) = {{\int }_{- ∞}}^{∞} f ( x ) {e}^{- 2 π i kx} d x .$$

The contrast adjustment section 16 adjusts the contrast of each of the plurality of regions based on the luminance level and the spatial frequency calculated by the spatial frequency calculation section 14. More specifically, the contrast adjustment section 16 adjusts the contrasts of the respective regions to mutually different extents. That is to say, each region (each segment) is given a different physical contrast. A specific model for the contrast adjustment by the contrast adjustment section 16 will be described in detail later.

The merging section 18 merges the plurality of regions, whose contrasts have been adjusted by the contrast adjustment section 16, into one image.

As described above, in the image processor 10 according to the present embodiment, the contrast adjustment is performed based on not only the luminance level but also the spatial frequency. Accordingly, uniform changes in perceived contrast across arbitrary adaptation luminance levels including very low luminance levels, arbitrary types of images, and arbitrary spatial frequencies can be achieved.

The constituent elements in the image processor 10 can be implemented in hardware, or some of all of them may be implemented in software. In the case where these constituent elements are implemented in software, they may be constructed by using a computer, this computer having a CPU (central processing unit) for executing various programs, a RAM (random access memory) functioning as a work area for executing such programs, and the like. Then, programs for realizing the functions of the respective constituent elements are executed in the computer, thus allowing the computer to operate as the respective constituent elements.

In order to prevent artificiality of the final image, it is preferable that the merging section 18 performs the merging after blurring the contours of the plurality of regions.

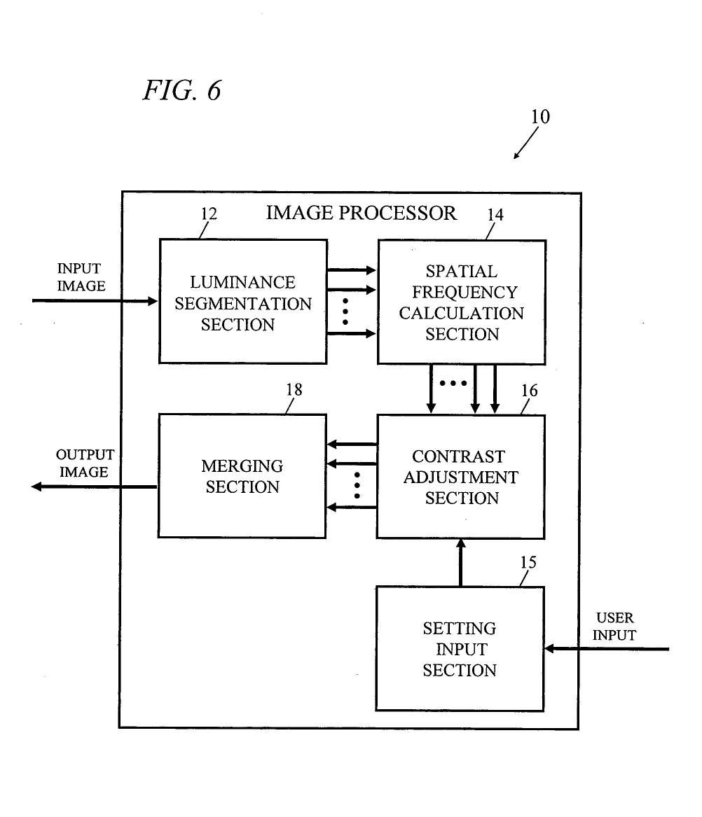

Optionally, as shown in FIG. 6, the image processor 10 may further include a setting input section 15. The setting input section 15 allows a user to designate an extent of adjustment by the contrast adjustment section 16.

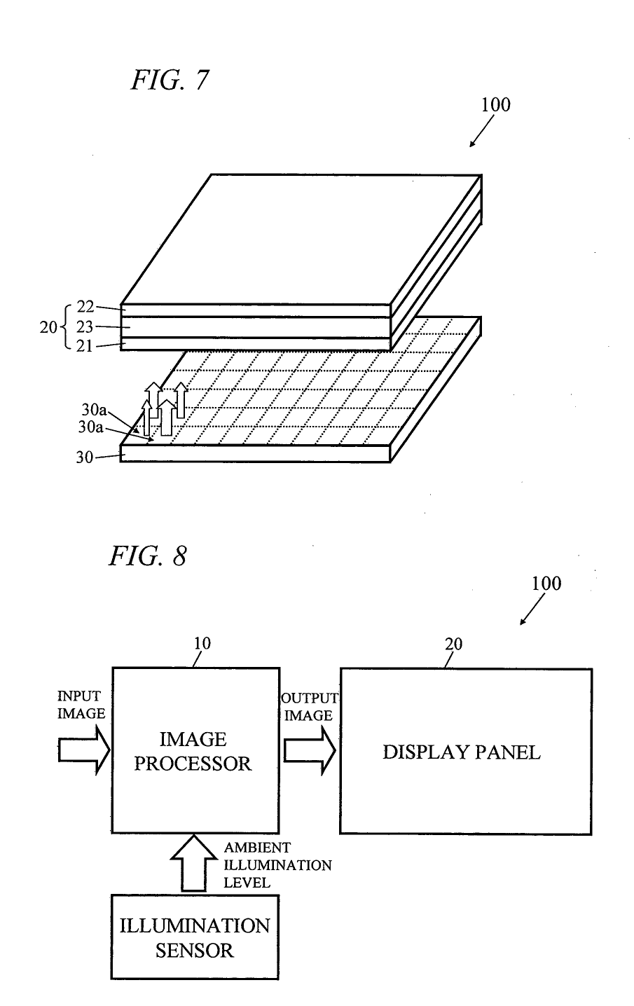

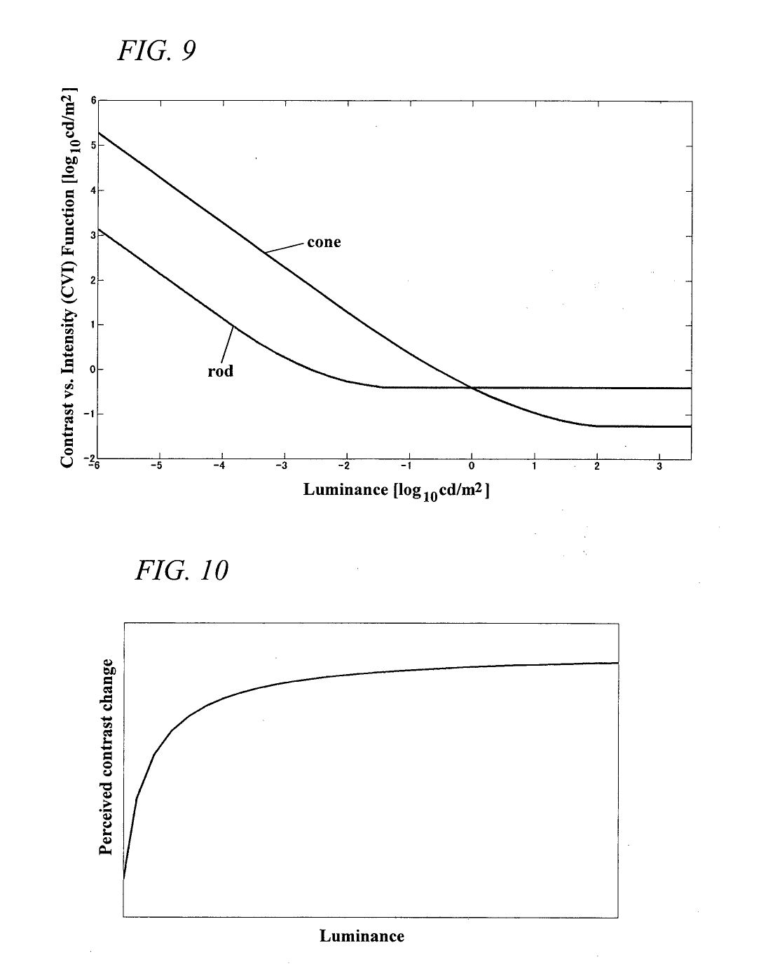

FIG. 7 shows an example of a specific configuration for obtaining a high dynamic range (HDR). The display panel 20 shown in FIG. 7 is a LCD panel which includes a pair of substrates 21 and 22, and a liquid crystal layer 23 provided between the pair of substrates 21 and 22. Therefore, the display device 100 shown in FIG. 7 further includes an illuminator 30 which emits light toward the display panel 20.

The illuminator 30 is a so-called “active backlight”. The illuminator 30 has a plurality of light emitting regions 30a, and is capable of controlling a luminance of each of the plurality of light emitting regions 30a. Each light emitting region 30a typically includes at least one light source (e.g., light-emitting diode). The display device 100 shown in FIG. 7 can reproduce very low and very high luminance levels because the display device 100 includes the illuminator 30 having the above construction.

As the illuminator 30, any of various known active backlights may be used. For example, an active backlight disclosed in WO 2009/054223 is suitably used. The entire disclosure of WO 2009/054223 is hereby incorporated by reference.

In addition, as shown in FIG. 8, the display device 100 may include an illumination sensor 40. Since contrast perception is also affected by an ambient illumination level, it becomes possible to achieve more uniform change in perceived contrast by detecting the ambient illumination level with the illumination sensor 40.

Hereinafter, a specific example of a model for suitably performing the contrast adjustment will be described.

An assessment of how the human visual system (HVS) perceives physical contrast changes can be carried out by conducting two psychophysical experiments, a “contrast scaling” experiment and a “contrast discrimination threshold” experiment.

(Contrast Scaling)

The goal of the contrast scaling experiment is to obtain uniform scalings of perceived contrast for human observers with respect to a given physical contrast for various adaptation luminance levels and various patterns of spatial frequency. In this experiment, a plurality of images are selected to cover different adaptation luminance levels, different patterns of spatial frequency, and different image types.

First, each of the images (i.e., stimuli) is segmented into a plurality of regions having different luminance levels. Next, for each of the regions, several different physical contrasts are applied. In other words, images having mutually different physical contrasts are obtained from each segment. As a result, several combination patterns of adaptation luminance levels and spatial frequencies are covered in each original image. Additionally, a high dynamic range (HDR) display which can reproduce not only very high luminance levels but also very low luminance levels is provided for this experiment.

Next, for each luminance level (i.e., each segment of an image), all possible pairs of images with different physical contrasts are shown to a subject one after another. For every pair, the subject is asked to answer a question: “Which image has stronger contrast in the region of interest?”.

The results of the above-described experiment are obtained in an n*n matrix F for each luminance level (where n is the number of physical contrasts). An element fᵢⱼ at row and column j in the matrix F represents that a stimulus (image) j is selected fᵢⱼ times by the subjects when the stimulus (image) j is compared against a stimulus (image) i. Obviously, the sum of fⱼᵢ and fᵢⱼ equals the total number of comparisons made for a pair of stimuli i and j. The diagonal cells in the matrix F are left vacant.

Note that this procedure, a so-called pair-wise comparison or 2-alternative forced choice (2AFC), may be replaced by another experimental method: rank-order. In the rank-order method, a subject is asked to sort all or a part of the stimuli instead of comparing each pair. The same n*n matrix can be obtained by either 2AFC or the rank-order method.

The results in the n*n matrix F may be analyzed according to the Law of Comparative Judgment disclosed in L. L. Thurstone, “Law of comparative judgment”, Psychological Review 34, pp. 273-286, 1927. A matrix P is constructed from the matrix F. An element pᵢⱼ in the matrix P is an observed ratio of the number times that stimulus j was judged greater than stimulus i. The diagonal cells in the matrix P are left vacant. Any symmetric cells in the matrix P sum up to unity (pᵢⱼ+pᵢⱼ=1.0).

From the matrix P, a basic transformation matrix X is constructed. An element xᵢⱼ in the matrix X is a unit normal deviate corresponding to the element pᵢⱼ. It can be positive for all values of pᵢⱼ greater than 0.50, and negative for all values of pᵢⱼ smaller than 0.50. Ratios of 1.00 and 0.00 cannot be used since the x values corresponding to these ratios would be unboundedly large. When such ratios occur, the corresponding cells of the matrix X are left vacant. Zeros are entered in the diagonal cells of the matrix X. In the end, the matrix X becomes skew-symmetric (xᵢⱼ=−xⱼᵢ) The final result, i.e., a least-square estimation of the scaling, can be obtained by averaging each column of the matrix X. Thus, contrast scaling for each luminance level is obtained.

(Contrast Discrimination Threshold)

Although the result of the contrast scaling experiment is obtained as mentioned above, it presents itself in an arbitrary unit. To convert the result of contrast scaling to a just noticeable difference (JND), another psychophysical experiment to measure a contrast discrimination threshold is conducted.

For each luminance level (i.e., each segment) of an image, several physical contrasts are chosen as references. At each reference contrast, a subject is asked to clarify his or her contrast discrimination threshold. This experiment can be done by using one of the threshold measurement methods such as the increment/decrement method, the staircase method, parameter estimation by sequential testing (PEST), QUEST, and so on. This experiment is also conducted on a HDR display, similarly to the contrast scaling experiment.

The increment/decrement method is the simplest way to measure a discrimination threshold. A pair consisting of a reference stimulus and a target stimulus is presented to a human subject. The target stimulus is set either at the same intensity as the reference stimulus (Case 1) or at a level which is greatly different from the reference stimulus (Case 2). The subject is asked to start changing the intensity of the target stimulus until he/she begins to see a difference (for Case 1) or begins to see the stimuli as the same (for Case 2).

The staircase method is disclosed in T. N. Cornsweet, “The staircase-method in psychophysics”, the American Journal of Psychology, 75(3), pp. 485-491, 1962. In the staircase method, a pair consisting of a reference stimulus and a target stimulus is presented to a subject as same as increment/decrement method. The intensity of the target stimulus is increased whenever the difference between the reference and the target stimuli is not discriminated, or decreased when a difference is perceived.

The PEST procedure is disclosed in M. M. Taylor and C. D. Creelman, “PEST: Efficient estimates on probability functions”, J. of Acoustical Society of America 41(4), pp. 782-787, 1967. In the PEST procedure, the intensity of the target stimulus is changed by the experimental program. Again, a pair consisting of a reference stimulus and a target stimulus is presented to a subject. The target stimulus is set at a level which is greatly different from the reference stimulus. At each step, a subject must answer a question: “Do you see a difference?”.

If the answer is yes, the intensity of the target stimulus is jumped close to the reference stimulus. Commonly, the width of the first jump is equal to the difference between the intensity of the reference and the initial intensity of the target stimulus. The experiment is basically conducted by repeating the above steps. Every time the subject answers differently from the previous time, the direction of changing the intensity of the target stimulus is inverted and the width of a jump is reduced to its half size. On the other hand, the intensity of the target stimulus is changed in the same direction and with the same width of a jump while the subject answers in the same way. One trial can be finished if the response of the subject becomes sufficiently constant.

The QUEST procedure is disclosed in A. B. Watson and D. G. Pelli, “QUEST: A Bayesian adaptive psychometric method”, Perception and Psychophysics 33(2), pp. 113-120, 1983. The QUEST procedure is a refinement of the PEST procedure. The QUEST procedure employs a human psychometric function to select each next stimulus level, instead of simply either continuing or half-inverting the change as in the PEST procedure.

(Converting the Results of Contrast Scaling to JND Unit)

After the two experiments, i.e., contrast scaling and contrast discrimination threshold experiments, the result of contrast scaling experiment is converted into a value of the just noticeable difference (JND) unit. The result of the contrast discrimination threshold experiment for each adaptation luminance level and each spatial frequency is regarded as one JND. Based on the result of the contrast discrimination threshold experiment (=1JND), the result of contrast scaling is re-scaled.

(A Model)

After re-scaling the result of contrast scaling into JND, those data are fitted to non-linear functions and then the non-linear functions are combined into a multi-dimensional model. First, a starting point for each set of data is computed and set by using a contrast detection threshold which can be computed by the contrast versus intensity (CVI) function. The CVI function is given as CVI(L)=TVI(L)/L, where TVI is the threshold versus intensity function (TVI) and L is the adaptation luminance level. Several TVI functions are disclosed in S. Daly, “The visible differences predictor: An algorithm for the assessment of image fidelity”, Digital Images and Human Vision, MIT Press, A. B. Watson, Ed., pp. 179—206, 1993; J. A. Ferwerda et al., “A model of visual adaptation for realistic image synthesis”, Proceedings of ACM SIGGRAPH 1996, pp. 249-258, 1996; P. G. J. Barten, “Contrast sensitivity of the human eye and its effects on image quality”, SPIE Optical Engineering Press, 1999; and M. Ashikhmin, “A tone mapping algorithm for high contrast images”, Proceedings of the 13th Eurographics Workshop on Rendering, pp. 145-155, 2002. Any of them can be employed for computing a contrast detection threshold. Each set of data is re-located with respect to the starting point and interpolated into a multi-dimensional model.

Based on the above-described model, a contrast adjustment by the contrast adjustment section 16 can be performed.

Note that the present invention is not limited to a configuration in which still images are inputted to the image processor 10. Moving images may be inputted to the image processor 10. In the case of moving images, the simplest way is to conduct all of the aforementioned steps for each frame. If motion vector analysis (e.g., using optical flows) is introduced in the image processor 10 (the display device 100), the computational cost will be highly reduced as compared to the case of conducting all the steps for every frame.

### INDUSTRIAL APPLICABILITY

According to the present invention, there is provided an image processor and an image processing method which can achieve uniform changes in perceived contrast across arbitrary adaptation luminance levels including very low luminance levels that cannot be reproduced on LDR displays, arbitrary types of images, and arbitrary spatial frequencies. The present invention is suitably used for image processors for high dynamic range (HDR) displays in general.

### REFERENCE SIGNS LIST

10 image processor
12 luminance segmentation section
14 spatial frequency calculation section
15 setting input section
16 contrast adjustment section
18 merging section
20 display panel
21, 22 substrate
23 liquid crystal layer
30 illuminator
30a light emitting region
100 display device

1. An image processor comprising:
a luminance segmentation section arranged to segment an input image into a plurality of regions having different luminance levels from one another;
a spatial frequency calculation section arranged to calculate a spatial frequency of each of the plurality of regions;
a contrast adjustment section arranged to adjust a contrast of each of the plurality of regions based on the luminance level and the spatial frequency calculated by the spatial frequency calculation section; and
a merging section arranged to merge the plurality of regions, whose contrasts have been adjusted by the contrast adjustment section, into one image.

2. The image processor of claim 1, wherein the merging section performs the merging after blurring contours of the plurality of regions.

3. The image processor of claim 1, wherein the contrast adjustment section adjusts the contrasts of the respective regions to mutually different extents.

4. The image processor of claim 1, further comprising a setting input section arranged to allow a user to designate an extent of adjustment by the contrast adjustment section.

5. A display device comprising:
the image processor of claim 1; and
a display panel arranged to display the image outputted from the image processor.

6. The display device of claim 5, wherein the display device is capable of performing display with a luminance of less than 3 cd/m² and with a luminance of more than 400 cd/m².

7. The display device of claim 5, wherein the display panel includes a pair of substrates and a liquid crystal layer provided between the pair of substrates.

8. The display device of claim 7, further comprising an illuminator arranged to emit light toward the display panel.

9. The display device of claim 8, wherein the illuminator has a plurality of light emitting regions and is capable of controlling a luminance of each of the plurality of light emitting regions.

10. The display device of claim 5, further comprising an illumination sensor arranged to detect an ambient illumination level.

11. An image processing method comprising the steps of:
segmenting an input image into a plurality of regions having different luminance levels from one another;
calculating a spatial frequency of each of the plurality of regions;
adjusting a contrast of each of the plurality of regions based on the luminance level and the calculated spatial frequency; and
merging the plurality of regions, whose contrasts have been adjusted, into one image.
